(19) United States
(12) Patent Application Publication
(10) Pub. No.: US 2010/0325138 A1
(43) Pub. Date: Dec. 23, 2010

(54) SYSTEM AND METHOD FOR PERFORMING VIDEO SEARCH ON WEB

(75) Inventors: HOU-HSIEN LEE, Tu-Cheng (TW); CHANG-JUNG LEE, Tu-Cheng (TW); CHIH-PING LO, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/546,700

(22) Filed: Aug. 25, 2009

(30) Foreign Application Priority Data
Jun. 18, 2009 (CN) 200910303401.3

(51) Int. Cl. G06F 17/30

(52) U.S. Cl. 707/759; 707/769; 707/713

(57) ABSTRACT

A video searching method downloads video files from websites by detecting name extensions of files on the websites, and classifies the video files according to specific information of each of the video files. The specific information is obtained by detecting an image of each of the video files. The image of each of the video files is compressed to obtain a thumbnail of the image of each of the video files. A database which stores the thumbnails of the images and the specific information of the video files is provided. The thumbnails of the images of video files relative to a topic of a search request in the database can be listed in sequence according to corresponding specific information of the relative video files, as a search result.

### BACKGROUND

1. Technical Field

The present disclosure relates to information searching systems, and more particularly to a system and a method for performing a video search on a web.

2. Description of Related Art

Currently, the Internet makes it easy to access information on websites. Keywords may be entered to perform a search, and search results may be indexed by a search engine. However, it is still a challenge for users to gather information most pertinent to the topic, since a considerable part of the search results may not be relevant. Therefore, search efficiency is low because users must browse through all the search results, including the results not relevant, this is especially true when searching for videos.

### BRIEF DESCRIPTION OF THE DRAWINGS

FIG. 1 is a block diagram of an embodiment of a video searching system.

FIG. 2 is a flowchart of an embodiment of a video searching method.

### DETAILED DESCRIPTION

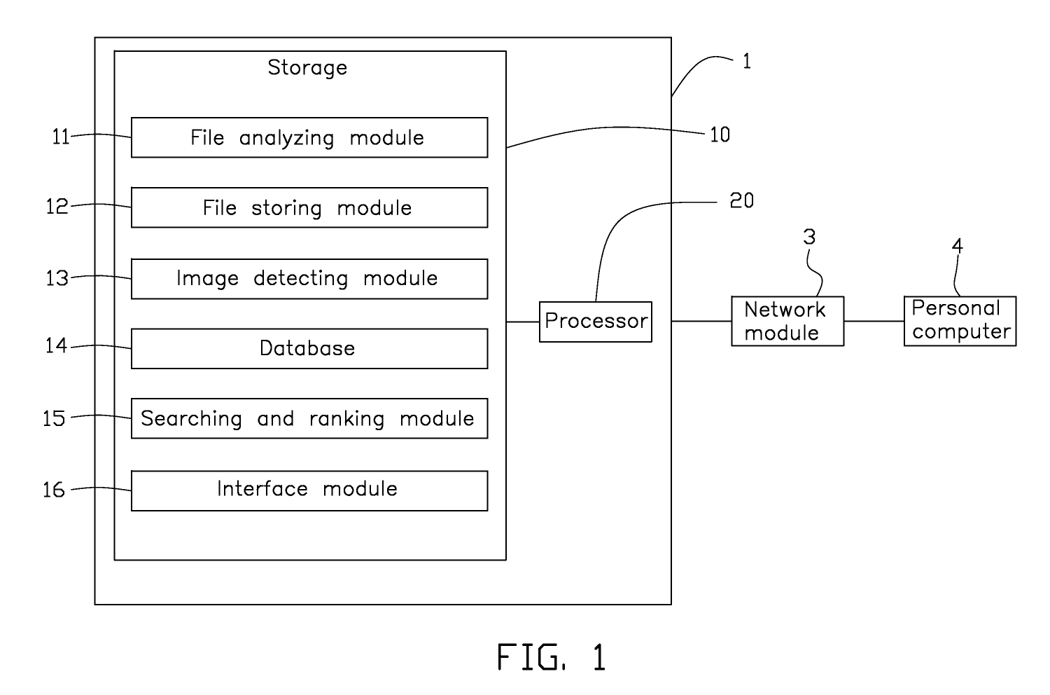

Referring to FIG. 1, an embodiment of a video searching system 1 includes a storage 10 and a processor 20. The storage 10 and the processor 20 are included in a computer server. The storage 10 includes a file analyzing module 11, a file storing module 12, an image detecting module 13, a database 14, a searching and ranking module 15, and an interface module 16. The file analyzing module 11, file storing module 12, image detecting module 13, database 14, searching and ranking module 15, and interface module 16 may include one or more computerized instructions and are executed by the processor 20. The video searching system 1 is operable to interface with a personal computer 4 via a network module 3, which is connected to the video searching system 1. The video searching system 1 is operable to provide users with an image database, with which users can perform effective video searches efficiently.

The file analyzing module 11 downloads video files from a plurality of websites via the network module 3. In this embodiment, the file analyzing module 11 recognizes the video files by detecting formats of files on the plurality of websites. It can be understood that the formats of the files denotes that the files are video files, music files, text files, or other files. The file analyzing module 11 can obtain the formats of the files according to name extensions of the files. For example, a file with a name extension of “.jpg”, “.jpeg”, “.bmp”, “.gif”, “.ico”, “.png”, “.tif”, “.avi”, “.wmv”, “.mpg”, “.ra”, “.flv”, or “.mov” is a video file. Each of the downloaded video files may include one or more images. The downloaded video files are stored in the file storing module 12.

The image detecting module 13 obtains a thumbnail of an image and specific information of each of the downloaded video files, and classifies each of the downloaded video files according to the specific information correspondingly. The specific information of each of the downloaded video files includes names of primary objects in the images, a degree of matching of each of the primary objects to a corresponding classification of the downloaded video file, and coordinates of the primary objects in the image. The specific information may also include time downloaded and website information of the video files. When a downloaded video file includes more than one image, the image detecting module 13 may obtain a thumbnail of one of the images. A percentage of an area of each of the primary objects that occupies the image is greater than a predetermined value, such as 30%.

It can be understood that known recognition technology is employed by the image detecting module 13 to obtain the specific information of the downloaded video files, and known image compression technology is employed by the image detecting module 13 to obtain the thumbnail of the image. For example, the image detecting module 13 may recognize the primary objects of each of the images by detecting color, brightness, or other features at different locations in the image. A video file may have a main classification and a secondary classification, depending on percentages of areas of the primary objects that occupy the image of the video file. A video file may be classified into a building classification and a person classification when a building and a person are detected in the image. The building classification may be a main classification of the video file, and the person classification may be a secondary classification of the video file, when there is a greater percentage of area of the building that occupies the image than that of the person. The image detecting module 13 may detect facial features of the person in the image, such as shape, complexion, or coordinates of individual sense organs of the person's face in the image. Therefore, the classification of the person in the image may represent a group that has the same specific features, such as “female”, “children”, or an individual person, such as “Michael Jackson.” The degree of matching of each of the primary objects to the corresponding classification of the downloaded video file can be determined according to the percentage of the area of the primary object that occupies a corresponding image of the video file. A greater percentage denotes a higher match degree. The match degree can be also determined according to specific features of the primary object, for example, a match degree of a cartoon face and the person classification may be lower than a match degree of a human face and the person classification, and a true building may have a higher match degree with the building classification than a model building.

The database 14 stores the thumbnail of the image and specific information of each of the downloaded video files. Each of the thumbnails of the images stored in the database 14 can be linked with a corresponding downloaded video files in the file storing module 12. In use, the interface module 16 may be operated on the personal computer 4 via the network module 3. The interface module 16 allows users to select or enter keywords to perform search requests in the database 14.

The searching and ranking module 15 searches thumbnails of the images of relative video files relative to topics of the entered keywords in the database 14 according to corresponding classifications of the downloaded video files, and ranks the miniature copies of the images of the relative video files according to the corresponding specific information, such as the degrees of matching of the primary objects with the corresponding classifications of the video files, the names of primary objects in each of the images, and the time information. For example, when a keyword “person” is entered, the searching and ranking module 15 may search and rank the miniature copies of the images of the video files with a person classification, which may be a main classification or a secondary classification. A thumbnail of an image of a human may be listed before a thumbnail of an image of a mask modeled in the image of a human face. Therefore, the thumbnails of the images of the relative video files may be listed by the personal computer 4 in sequence. The listed thumbnails of the images can be linked with the downloaded video files correspondingly according to the website information.

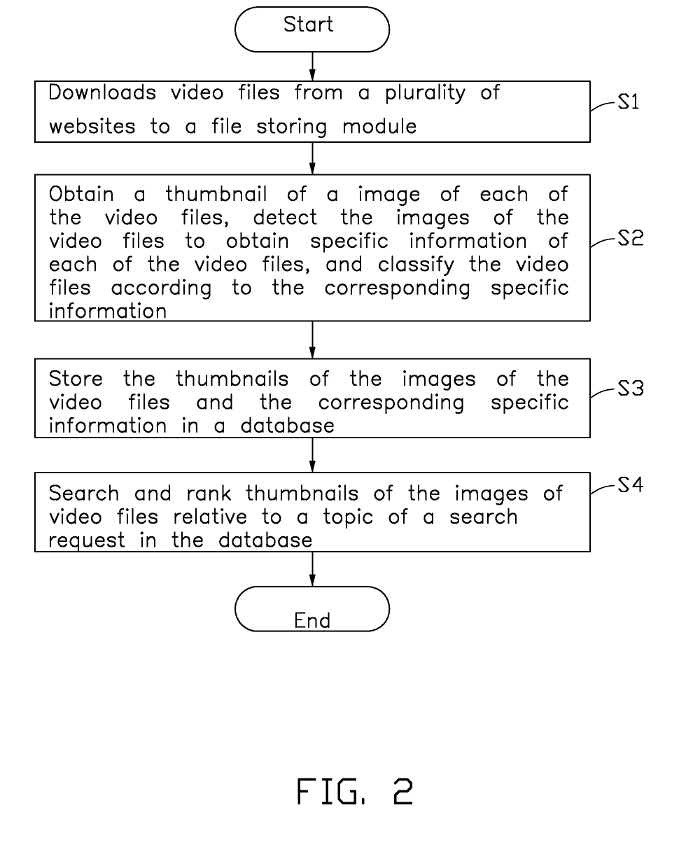

Referring to FIG. 2, an embodiment of a video searching method includes the following steps.

Step S1: the file analyzing module 11 downloads video files from a plurality of websites to the file storing module 12 through the network module 3. The video files are recognized by detecting the name extensions of the files on the plurality of websites.

Step S2: the image detecting module 13 obtains a thumbnail of an image and the specific information of each of the downloaded video files, and classifies the downloaded video files according to the specific information correspondingly. The image detecting module 13 obtains the specific information of each of the downloaded video files by detecting the corresponding image included in the downloaded video file. Each of the downloaded video files has a main classification and a secondary classification, depending on percentages of the primary objects in the image of the video file.

Step S3: the thumbnails of the images of the video files and the corresponding specific information are stored in the database 14. Each of the specific information stored in the database 14 can be linked with a corresponding downloaded video file in the file storing module 12. The database 14 provides the users with the specific information of the downloaded video files. The database 14 allows the users to accept and perform image searches via the interface module 16 which is communicated with the personal computer 4 via the network module 3. In other embodiments, the specific information can be stored in the database 14 without being linked with the downloaded video files in the file storing module 12.

Step S4: the searching and ranking module 15 searches and ranks thumbnails of the images of video files relative to a topic of a search request in the database 14. The thumbnails of the images of the video files relative to the topic of the search request can be searched according to the main classification and the secondary classification of the video files, and can be ranked according to the corresponding specific information, such as the degrees of matching of the primary objects and the corresponding classifications of the video files, the names of primary objects in each of the images, and the time information.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A video searching system comprising:
a processor; and
a storage device connected to the processor and storing a plurality of modules each of which contains one or more computerized instructions to be executed by the processor, wherein the plurality of modules comprise:
a file analyzing module to recognize video files from a plurality of websites by detecting name extensions of files on the plurality of websites;
a file storing module to store the video files;
an image detecting module to obtain a thumbnail of an image of each of the video files, and specific information of each of the video files by detecting the image of each of the video files, and classifying each of the video files into at least one classification according to the specific information;
a database storing the thumbnail of the image, and the specific information of each of the video files; and
a searching and ranking module to search the thumbnails of the images of video files relative to a topic of a search request in the database according to the at least one classification of each of the video files, and rank the thumbnails of the images of the video files relative to the topic of the search request in the database according to the corresponding specific information.

2. The system of claim 1, wherein the specific information of each of the stored video files comprises names of primary objects in the image of the stored video file, a degree of matching of each of the primary objects to the at least one classification of the stored video file, coordinates of the primary objects in the image, and time downloaded and website information of each of the stored video files.

3. The system of claim 2, wherein a percentage of an area of each of the primary objects that occupies the corresponding image is greater than a predetermined value.

4. The system of claim 3, wherein the degree of matching of each of the primary objects to the at least one classification of the stored video file is determined according to the percentage of the area of the primary object that occupies the image.

5. The system of claim 1, wherein each of the thumbnails of the images is linked with a corresponding stored video file in the file storing module.

6. The system of claim 1, wherein the formats of files on the plurality of websites comprise name extensions of the files.

7. The system of claim 1, wherein the at least one classification of each of the video files comprises a main classification and a secondary classification.

8. The system of claim 2, wherein the degree of matching of each of the primary objects to the at least one classification of the stored video file is determined according to specific features of the primary object.

9. A video searching method comprising:
downloading video files from a plurality of websites to a file storing module via obtaining formats of files on the plurality of websites;
detecting an image of each of the video files to obtain specific information of each of the video files, and classifying the video files according to the specific information correspondingly;
compressing the image of each of the video files to obtain a thumbnail of the image of each of the video files;
storing the thumbnails of the images of the video files and the corresponding specific information in a database;
searching the thumbnails of the images of video files relative to a topic of a search request in the database according to the at least one classification of each of the video files; and
ranking the thumbnails of the images of the video files relative to the topic of the search request according to the corresponding specific information.

10. The method of claim 9, wherein each of the video files are classified in a main classification and a secondary classification, depending on percentages of areas of primary objects that occupy the image of each of the video files correspondingly.

11. The method of claim 9, wherein the specific information of each of the video files comprises names of the primary objects in the image of the stored video file, a degree of matching of each of the primary objects to the at least one classification of the video file, coordinates of the primary objects in the image, and time downloaded and website information of the video file.

12. The method of claim 9, wherein the formats of the files on the plurality of websites are obtained by detecting name extensions of the files.
